(19) United States
(12) Patent Application Publication
(10) Pub. No.: US 2009/0218026 A1
(43) Pub. Date: Sep. 3, 2009

(54) Tire and Crosslinkable Elastomeric Composition

(76) Inventors: Luca Giannini, Milano (IT); Luigi Fino, Milano (IT); Maurizio Galimberti, Milano (IT); Attilio Citterio, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/085,690

(22) PCT Filed: Nov. 29, 2005
(86) PCT No.: PCT/EP2005/012718

§ 371 Date: May 18, 2009

(51) Int. Cl. B60C 1/00; C08L 21/00; C08K 3/34; C08K 5/44; C08K 5/09

(52) U.S. Cl. 152/547; 428/339; 152/450

(57) ABSTRACT

Tire including at least one structural element including a crosslinked elastomeric material obtained by crosslinking a crosslinkable elastomeric composition includes: (a) 100 phr of at least one diene elastomeric polymer; (b) 5 phr to 120 phr, preferably 10 phr to 80 phr, more preferably 20 phr to 50 phr, of at least one layered material modified with at least one alkyl ammonium or alkyl phosphonium salt, the layered material having an individual layer thickness of 0.01 nm to 30 nm, preferably 0.05 nm to 15 nm, more preferably 0.1 nm to 2 nm; (c) 0.05 phr to 2 phr, preferably 0.1 phr to 1 phr, more preferably 0.2 phr to 0.5 phr, of at least one N-acyl-sulfenyl amide; and (d) 0.3 phr to 5 phr, preferably 0.5 phr to 4 phr, of least one organic or inorganic acid or a derivative thereof selected from: carboxylic acids, phosphoric acids, sulfonic acids, boric acids, or derivatives thereof. Preferably, the at least one structural element is selected from bead filler, sidewall insert, treat underlayer, tread base.

The present invention relates to a tire and to a crosslinkable elastomeric composition.

More in particular the present invention relates to a tire including at least one structural element obtained by crosslinking a crosslinkable elastomeric composition comprising at least one diene elastomeric polymer, at least one modified nanosized layered material, at least one N-acyl-sulphenyl amide and at least one organic or inorganic acid or a derivative thereof.

Moreover, the present invention also relates to a crosslinkable elastomeric composition comprising at least one diene elastomeric polymer, at least one modified nanosized layered material, at least one N-acyl-sulphenyl amide and at least one organic or inorganic acid or a derivative thereof as well as to a crosslinked manufactured article obtained by crosslinking said crosslinkable elastomeric composition.

In the rubber industry, in particular that of tires for vehicle wheels, it is known practice to add nanosized layered material to crosslinkable elastomeric composition in order to improve their mechanical properties (both static and dynamic).

For example, European Patent Application EP 1,193,085 relates to a tire with a rubber/cord laminate, sidewall insert and apex including a rubber composition comprising, based upon parts by weight of an ingredient per 100 parts by weight elastomer (phr):
(A) 100 phr of at least one diene-base elastomer;
(B) 30 phr to 100 phr of particulate reinforcement dispersed within said elastomer(s) selected from intercalated smectite, preferably montmorillonite, clay particles, carbon black, synthetic amorphous silica and silica treated carbon black, comprised of:
   (1) 1 phr to 10 phr of said intercalated, layered, thin, substantially two dimensional smectite, preferably montmorillonite, clay particles of which at least a portion thereof is in a form of thin, flat, substantially two dimensional exfoliated platelets derived from said intercalated clay; and
   (2) 20 phr to 99 phr of at least one additional reinforcing filler comprised of carbon black, synthetic amorphous silica and silica treated carbon black.

The abovementioned rubber composition is said to have improved stiffness and tensile modulus with only a small increase of Tan delta values.

United States Patent Application 2003/0004250 relates to a light weight rubber composition comprising (1) an amino group containing rubbery polymer, wherein said amino group containing rubbery polymer contains from about 0.1 weight percent to about 20 weight percent of a monomer containing an amino group, and (2) from about 0.1 phr to about 25 phr of a 2:1 layered silicate clay. The abovementioned rubber composition, having improved tensile strength and elongation at break, is said to be useful in the manufacturing of rubber articles such as power transmission belts and tires, in particular tire tread band and sidewalls.

International Patent Application WO 05/002883 in the name of the Applicant, relates to a tyre for vehicle wheels of a cap and base construction, comprising:
a carcass structure with at least one carcass ply shaped in a substantially toroidal configuration, the opposite lateral edges of which are associated with respective right-hand and left-hand bead wires, each bead wire being enclosed in a respective bead;
a belt structure comprising at least one belt strip applied in a circumferentially external position relative to said carcass structure;
a tread band superimposed circumferentially on said belt structure comprising a radially outer layer designed to come into contact with the ground and a radially inner layer interposed between said radially outer layer and said belt structure;
a pair of sidewalls applied laterally on opposite sides relative to said carcass structure;
   wherein said radially inner layer includes a crosslinked elastomeric composition comprising:
(a) at least one diene elastomeric polymer;
(b) at least one layered inorganic material having an individual layer thickness of from 0.01 nm to 30 nm, preferably of from 0.05 nm to 15 nm, said layered inorganic material being present in an amount of from 1 phr to 120 phr, preferably of from 5 phr to 80 phr.

The addition of said layered inorganic material is said to increase the mechanical properties of the elastomeric composition without observing undesired effects on its remaining properties (i.e. viscosity, hysteresis, green adhesiveness).

International Patent Application WO 05/049340 in the name of the Applicant, relates to a tire for vehicle wheels, comprising:
a carcass structure shaped in a substantially toroidal configuration, the opposite lateral edges of which are associated with respective right-hand and left-hand bead wires to form respective beads;
a belt structure applied in a radially external position with respect to said carcass structure;
a tread band radially superimposed on said belt structure;
at least one layer of crosslinked elastomeric material applied in a radially internal position with respect to said tread band;
a pair of sidewalls applied laterally on opposite sides with respect to said carcass structure;
   wherein said at least one layer of crosslinked elastomeric material has the following characteristics:
a dynamic elastic modulus (E′), measured at 70° C., not lower than 20 MPa, preferably of from 25 MPa to 50 MPa;
a ratio between tensile modulus at 100% elongation (M100) and tensile modulus at 10% elongation (M10) not lower than 1.5, preferably of from 2 to 5.

Preferably said at least one layer of crosslinked elastomeric material is placed between said tread band and said belt structure.

Preferably, said crosslinked elastomeric material comprises:
(a) at least one diene elastomeric polymer;
(b) at least one layered inorganic material having an individual layer thickness of from 0.01 nm to 30 nm, preferably from 0.05 nm to 15 nm, more preferably from 0.1 nm to 2 nm, said layered inorganic material being present in an amount of from 1 phr to 120 phr, preferably from 5 phr to 80 phr.

However, the use of said layered materials, in particular in the case of modified layered materials, may cause some drawbacks

The Applicant has noticed that, the use of modified nanosized layered materials, in particular nanosized layered materials modified with at least one alkyl ammonium or alkyl phosphonium salt, may cause a premature crosslinking of said elastomeric compositions (scorching phenomena) at the temperature commonly used during processing, so that the elastomeric compositions may partially crosslink before the molding and vulcanization steps.

The Applicant has faced the problem of providing elastomeric compositions comprising modified nanosized layered materials showing an increased scorch time so as to avoid their premature crosslinking (scorching phenomena).

The Applicant has now found that it is possible to obtain crosslinkable elastomeric compositions comprising modified nanosized layered materials, in particular nanosized layered materials modified with at least one alkyl ammonium or alkyl phosphonium salt, that may be advantageously used in the production of crosslinked manufactured products, in particular in the manufacturing of tires, more in particular in the manufacturing of inner structural elements of a tire, by adding to the crosslinkable elastomeric compositions at least one N-acyl-sulfenyl amide and at least one organic or inorganic acid or a derivative thereof.

Moreover, the Applicant has found that the combination of a N-acyl-sulfenyl amide with an inorganic or organic acid or a derivative thereof, shows a synergistic effect on the scorch time of the obtained crosslinkable elastomeric compositions. Furthermore, the crosslinked elastomeric compositions so obtained show good or even improved mechanical properties (both static and dinamic). Moreover, the addition of said N-acyl-sulphenyl amide and of said organic or inorganic acid or a derivative thereof, does not negatively affect the vulcanization rate of the obtained crosslinkable elastomeric compositions.

According to a first aspect, the present invention relates to a tire comprising at least one structural element including a crosslinked elastomeric material obtained by crosslinking a crosslinkable elastomeric composition comprising:
(a) 100 phr of at least one diene elastomeric polymer;
(b) from 5 phr to 120 phr, preferably from 10 phr to 80 phr, more preferably from 20 phr to 50 phr, of at least one layered material modified with at least one alkyl ammonium or alkyl phosphonium salt, said layered material having an individual layer thickness of from 0.01 nm to 30 nm, preferably of from 0.05 nm to 15 nm, more preferably of from 0.1 nm to 2 nm;
(c) from 0.05 phr to 2 phr, preferably from 0.1 phr to 1 phr, more preferably from 0.2 phr to 0.5 phr, of at least one N-acyl-sulfenyl amide;
(d) from 0.3 phr to 5 phr, preferably from 0.5 phr to 4 phr, more preferably from 0.7 phr to 2 phr, of at least one organic or inorganic acid or a derivative thereof selected from: carboxylic acids, phosphoric acids, sulfonic acids, boric acids, or derivatives thereof.

For the purposes of the present description and of the claims which follow, the term “phr” means the parts by weight of a given component of the crosslinkable elastomeric composition per 100 parts by weight of the elastomeric polymer(s).

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

According to one preferred embodiment, the tire comprises:
a carcass structure of a substantially toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure;
at least one structural element selected from bead filler, sidewall insert, tread underlayer, tread base, including a crosslinked elastomeric material obtained by crosslinking a crosslinkable elastomeric composition above disclosed.

According to a further preferred embodiment, said sidewall insert extends radially from a position corresponding to the bead structure to a position corresponding to a tread lateral edge. Said sidewall insert is usually used in the case of extended mobility tires such as, for example, run flat tires.

According to a further preferred embodiment, said tread underlayer is a layer of a crosslinked elastomeric material applied in a radially inner position with respect to said tread band.

According to a further preferred embodiment, said tread band is of cap and base construction and comprises a radially inner layer or tread base and a radially outer layer or tread cap. Preferably, said radially inner layer or tread base has a thickness of at least 10%, preferably of from 20% to 70%, with respect to the total thickness of the tread band.

Preferably, said structural element has a dynamic elastic modulus (E′), measured at 70° C., not lower than 10 MPa, more preferably of from 15 MPa to 80 MPa.

Preferably, said structural element has a tensile modulus at 100% elongation (100% Modulus) not lower than 4 MPa, preferably of from 5 MPa to 20 MPa.

Preferably, said structural element has a IRHD hardness, measured at 23° C. not lower than 70, more preferably of from 80 to 98.

The dynamic elastic modulus (E′) may be measured using an Instron dynamic device in the traction-compression mode. The tensile modulus may be measured according to Standard ISO 37:1994. The IRHD hardness may be measured according to Standard ISO 48:1994. Further details regarding the above measurement methods will be given in the examples which follow.

According to a further aspect, the present invention relates to a crosslinkable elastomeric composition comprising:
(a) 100 phr of at least one diene elastomeric polymer;
(b) from 5 phr to 120 phr, preferably from 10 phr to 80 phr, more preferably from 20 phr to 50 phr, of at least one layered material modified with at least one alkyl ammonium or alkyl phosphonium salt, said layered material having an individual layer thickness of from 0.01 nm to 30 nm, preferably of from 0.05 nm to 15 nm, more preferably of from 0.1 nm to 2 nm;
(c) from 0.05 phr to 2 phr, preferably from 0.1 phr to 1 phr, more preferably from 0.2 phr to 0.5 phr, of at least one N-acyl-sulfenyl amide;
(d) from 0.3 phr to 5 phr, preferably from 0.5 phr to 4 phr, more preferably from 0.7 phr to 2 phr, of at least one organic or inorganic acid or a derivative thereof selected from: carboxylic acids, phosphoric acids, sulfonic acids, boric acids, or a derivative thereof.

According to one preferred embodiment, said crosslinkable elastomeric composition may further comprise (e) at least one carbon black reinforcing filler.

According to a further preferred embodiment, said crosslinkable elastomeric composition may further comprise (f) at least one silane coupling agent.

According to a further preferred embodiment, said crosslinkable elastomeric composition may further comprise (g) at least one methylene donor compound.

According to a further preferred embodiment, said crosslinkable elastomeric composition may further comprise (h) at least one methylene acceptor a compound.

According to a further preferred embodiment, said crosslinkable elastomeric composition may further comprise (i) discontinuous fibres.

According to a further aspect, the present invention relates to a crosslinked manufactured article obtained by crosslinking a crosslinkable elastomeric composition above reported.

According to one preferred embodiment, said diene elastomeric polymer (a) may be selected from those commonly used in sulfur-crosslinkable elastomeric materials, that are particularly suitable for producing tires, that is to say from elastomeric polymers or copolymers with an unsaturated chain having a glass transition temperature (T_{g}) generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene or isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, said diene elastomeric polymer (a) may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

According to one preferred embodiment, said crosslinkable elastomeric composition comprises at least 10% by weight, preferably from 20% by weight to 100% by weight, with respect to the total weight of the at least one diene elastomeric polymer (a), of natural or synthetic cis-1,4-polyisoprene.

The above reported crosslinkable elastomeric composition may optionally comprise (a′) at least one elastomeric polymer of one or more monoolefins with an olefinic comonomer or derivatives thereof. The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

The above reported elastomeric polymers, i.e. the diene elastomeric polymer (a) and the elastomeric polymer (a′), may optionally be functionalized by reaction with suitable terminating agents or coupling agents. In particular, the diene elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European Patent EP 451,604, or U.S. Pat. No. 4,742,124, or U.S. Pat. No. 4,550,142).

The above reported elastomeric polymers, i.e. the diene elastomeric polymer (a) and the elastomeric polymer (a′), may optionally include at least one functional group selected from epoxy groups, hydroxy groups, polyether groups, or mixtures thereof.

According to one preferred embodiment, said layered material modified with at least one alkyl ammonium or alkyl phosphonium salt (b) may be selected, for example, from the following compounds: phyllosilicates such as, smectites, for example, montmorillonite, bentonite, nontronite, beidellite, volkonskoite, hectorite, saponite, sauconite; vermiculite; halloisite; sericite; aluminate oxides; hydrotalcite; or mixtures thereof; said compounds being modified with at least one alkyl ammonium or alkyl phosphonium salt.

According to one preferred embodiment, said alkyl ammonium or alkyl phosphonium salt may be selected from quaternary ammonium or phosphonium salts having general formula (I):

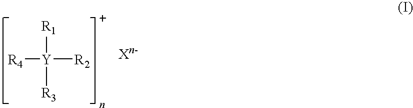

wherein:
Y represents N or P;
R₁, R₂, R₃ and R₄, which may be equal or different from each other, represent a linear or branched C₁-C₂₀ alkyl or hydroxyalkyl group; a linear or branched C₁-C₂₀ alkenyl or hydroxyalkenyl group; a group —R₅—SH or —R₅—NH wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group possibly containing hetero atom such as oxygen, nitrogen or sulfur;
Xⁿ⁻ represents an anion such as the chloride ion, the sulphate ion or the phosphate ion;
n represents 1, 2 or 3.

The unmodified layered material (i.e. the layered material not modified with at least one alkyl ammonium or alkyl phosphonium salt) generally contain exchangeable ions such as sodium (Na⁺), calcium (Ca²⁺), potassium (K⁺), magnesium (Mg²⁺), hydroxide (HO⁻), or carbonate (CO₃²⁻) present at the interlayer surfaces.

Said alkyl ammonium or alkyl phosphonium salt is capable of undergoing ion exchange reactions with the ions present at the interlayers surfaces of the layered materials.

The modification of the above reported layered material may be carried out by treating said layered material with at least one alkyl ammonium or alkyl phosphonium salt before adding it to the elastomeric polymers. Alternatively, the layered material and the at least one alkyl ammonium or alkyl phosphonium salt may be separately added to the elastomeric polymers.

The treatment of the layered material with the at least one alkyl ammonium or alkyl phosphonium salt may be carried out according to known methods such as, for example, by an ion exchange reaction between the layered material and the at least one alkyl ammonium or alkyl phosphonium salt: further details are described, for example, in U.S. Pat. No. 4,136,103, U.S. Pat. No. 5,747,560, or U.S. Pat. No. 5,952,093.

Examples of layered materials modified with at least one alkyl ammonium or alkyl phosphonium salt (b) which may be used according to the present invention and are available commercially are the products known by the name of Dellite® 67G, Dellite® 72T, Dellite® 43B, from Laviosa Chimica Mineraria S.p.A.; Cloisite® 25A, Cloisite® 10A, Cloisite® 15A, Cloisite® 20A, from Southern Clays; Nanofil® 5, Nanofil® 8, Nanofil® 9, from Süd Chemie.

According to one preferred embodiment, the N-acyl-sulphenyl amide (c) may be selected from compounds having general formula (II):

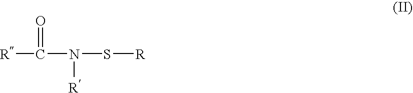

wherein:
R represents a linear or branched C₁-C₂₀ alkyl group; a C₅-C₁₈ cycloalkyl group;
R′ represents a hydrogen atom; a linear or branched C₁-C₂₀ alkyl group; a C₆-C₁₈ aryl group; a C₇-C₂₀ arylalkyl or alkylaryl group; or, R′ and R, considered jointly together with the nitrogen atom and the sulfur atom to which they are linked, represent a saturated or unsatured C₃-C₁₀ heterocyclic ring;
R″ represents a hydrogen atom; a linear or branched C₁-C₂₀ alkyl group; a C₆-C₁₈ aryl group; a C₇-C₂₀ arylalkyl or alkylaryl group; a —(CH₂)ₙ—CO—NR′—SR group wherein n is an integer of from 1 to 20, extremes included, and R′ and R have the same meanings above disclosed; a —Ar—CO—NR′—SR group wherein Ar represents a C₆-C₁₈ arylidene group, and R′ and R have the same meanings above disclosed; a —Ar—CRₐ═CR_{b}—Ar—CO—NR′—SR group wherein Ar as the same meanings above disclosed, Rₐ and R_{b}, which may be equal or different from each other, represent a hydrogen atom, a linear or branched C₁-C₂₀ alkyl group, and R′ and R have the same meanings above disclosed; a R_{c}—NH— group or a (R_{c})₂—N— group wherein the R_{c} groups, which may be equal or different from each other, represent a linear or branched C₁-C₂₀ alkyl groups; a R_{d}—CONH— group or a R_{d}—CON—Rₑ— group wherein R_{d} and Rₑ, which may be equal or different from each other, represent a linear or branched C₁-C₂₀ alkyl groups; or, R″ and R′, considered jointly together with the nitrogen atom and the carbon atom to which they are linked, represent a saturated or unsatured C₃-C₁₀ heterocyclic ring.

Specific examples of R groups are: methyl, ethyl, propyl, isopropyl, butyl, t-butyl, isobutyl, pentyl, hexyl, octyl, allyl, methallyl, 2-butenyl, propenyl, hexenyl, octenyl, cyclopentyl, cyclohexyl, cyclodecyl, cyclododecyl.

Specific examples of R′ groups are: methyl, ethyl, propyl, isopropyl, butyl, t-butyl, isobutyl, pentyl, hexyl, octyl, allyl, methallyl, 2-butenyl, propenyl, hexenyl, octenyl, benzyl, phenyl, naphthyl, methylbenzyl, ethylbenzyl, diphenyl, methylphenyl, ethylphenyl, methylnaphthyl, ethylnaphthyl.

Specific examples of R′ and R, considered jointly together with the nitrogen atom and the sulfur atom to which they are linked, are: isothiazolyl, 4-phenylisothiazolyl, 1,2-benzoisothiazolyl-3(2H)-one.

Specific examples of R″ groups are: methyl, ethyl, propyl, isopropyl, butyl, t-butyl, isobutyl, pentyl, hexyl, octyl, allyl, methallyl, 2-butenyl, propenyl, hexenyl, octenyl, benzyl, phenyl, naphthyl, methylbenzyl, ethylbenzyl, diphenyl, methylphenyl, ethylphenyl, methylnaphthyl, ethylnaphtyhl.

Specific examples of Rₐ and R_{b} groups are: methyl, ethyl, propyl, isopropyl, butyl, t-butyl, isobutyl, pentyl, hexyl, octyl, allyl, methallyl, 2-butenyl, propenyl, hexenyl, octenyl.

Specific example of Ar groups are benzylidene, naphthylidene, tolylidene.

Specific examples of R_{c}, R_{d} and Rₑ groups are: methyl, ethyl, propyl, isopropyl, butyl, t-butyl, isobutyl, pentyl, hexyl, octyl, allyl, methallyl, 2-butenyl, propenyl, hexenyl, octenyl.

Specific examples of R′ and R′, considered jointly together with the nitrogen atom and the carbon atom to which they are linked, are: glutaramide, caprolactame, succinimide, maleimide, phthalimide, hydantoine.

According to one preferred embodiment, the N-acyl-sulfenyl amide is N-cyclohexylthiophthalimide.

According to one preferred embodiment, the carboxylic acids may be selected from: maleic acid; fumaric acid; citraconic acid; itaconic acid; acrylic acid; methacrylic acid; butanoic acid; pentanoic acid; hexanoic acid; heptanoic acid; octanoic acid; phthalic acid; salicylic acid; benzoic acid; sulfur containing carboxylic acids such as, for example, thiodipropionic acid, dithiodipropionic acid; or mixtures thereof.

According to one preferred embodiment, the phosphoric acids may be selected from: metaphosphoric acid; triphosphoric acid; pyrophosphoric acid; alkyl phosphoric acids such as, for example, di-2-ethylhexyl phosphoric acid, mono-dodecyl phosphoric acid; aryl or alkylaryl phosphoric acids, such as, for example, phenyl phosphoric acid, tolyl phosphoric acid, xylyl phosphoric acid, octylphenyl phosphoric acid; or mixtures thereof.

According to one preferred embodiment, the sulfonic acids may be selected from: alkyl sulfonic acids such as, for example, methanesulfonic acid, ethanesulfonic acid, propane sulfonic acid, 2-butane sulfonic acid; aryl or alkylaryl sulfonic acids such as, for example, toluenesulfonic acid, p-dodecylsulfonic acid, tetra-propylbenzenesulfonic acid, acetyl p-dodecylsulfonic acid, 1-naphthalenesulfonic acid, 2-naphthalene sulfonic acid; or mixtures thereof.

According to one preferred embodiment, the boric acids may be selected from: metaboric acid; pyroboric acid; alkyl boric acids such as, for example, methylboric acid, ethylboric acid, butylboric acid; aryl boric acids such as, for example, phenylboric acid; or mixtures thereof.

According to one preferred embodiment, the derivatives of the above reported organic or inorganic acids, may be selected from: esters, anhydrides, halides, imides, amides, or mixtures thereof, in particular anhydrides.

According to one preferred embodiment, said organic or inorganic acid or a derivative thereof (d) is phthalic anhydride.

As disclosed above, said crosslinkable elastomeric composition may further comprise (e) at least one carbon black reinforcing filler.

According to one preferred embodiment, said carbon black reinforcing filler may be selected from those having a surface area of not less than 20 m²/g (determined by CTAB absorption as described in Standard ISO 6810:1995).

According to one preferred embodiment, said carbon black reinforcing filler is present in the crosslinkable elastomeric composition in an amount of from 0 phr to 120 phr, preferably of from 20 phr to 90 phr.

As disclosed above, said crosslinkable elastomeric composition may further comprise (f) at least one silane coupling agent.

According to one preferred embodiment, said silane coupling agent may be selected from those having at least one hydrolizable silane group which may be identified, for example, by the following general formula (III):

(R₅)₃Si—CₙH₂ₙ—X (III)

wherein the groups R₅, which may be equal or different from each other, are selected from: alkyl, alkoxy or aryloxy groups or from halogen atoms, on condition that at least one of the groups R₅ is an alkoxy or aryloxy group; n is an integer of from 1 to 6, extremes included; X is a group selected from: nitroso, mercapto, amino, epoxide, vinyl, imide, chloro, —(S)ₘCₙH₂ₙ—Si—(R₅)₃, or —S—COR₅, in which m and n are integers of from 1 to 6, extremes included and the groups R₅ are defined as above.

Among the silane coupling agents that are particularly preferred are bis(3-triethoxysilylpropyl)tetrasulphide or bis(3-triethoxysilylpropyl)disulphide. Said coupling agents may be used as such or as a suitable mixture with an inert filler (for example carbon black) so as to facilitate their incorporation into the elastomeric polymer.

According to one preferred embodiment, said silane coupling agent is present in the elastomeric composition in an amount of from 0 phr to 10 phr, preferably of from 0.5 phr to 5 phr.

As disclosed above, said crosslinkable elastomeric composition may further comprise (g) at least one methylene donor compound.

According to one preferred embodiment said methylene donor compound may be selected, for example, from: hexamethylenetetramine (HMT); hexamethoxymethylmelamine (HMMM); formaldehyde; paraformaldehyde; trioxane; 2-methyl-2-nitro-1-propanal; substituted melamine resins such as N-substituted oxymethylmelamine resins; glycoluril compounds such as tetramethoxymethyl glycoluril; urea-formaldheyde resins such as butylated urea-formaldheyde resins; or mixtures thereof. Hexamethylenetetramine (HMT) or hexamethoxymethylmelamine (HMMM) are particularly preferred.

According to one preferred embodiment, said methylene donor compound is present in the elastomeric composition in an amount of from 0 phr to 15 phr, preferably of from 0.1 phr to 10 phr.

As disclosed above, said crosslinkable elastomeric composition may further comprise (h) at least one methylene acceptor compound.

According to one preferred embodiment, said methylene acceptor compound may be selected, for example, from: resorcinol; catechol; hydroquinone; pyrogallol; phloroglucinol; 1-naphthol; 2-naphthol; phenolic resins obtained from the condensation of an optionally substituted phenol with an aldehyde such as, for example, formaldehyde, acetaldehyde, furfural (for example, resorcinol-formaldehyde resin); or mixtures thereof. Resorcinol is particularly preferred.

According to one preferred embodiment, said methylene acceptor compound is present in the elastomeric composition in an amount of from 0 phr to 20 phr, preferably of from 0.4 phr to 15 phr.

Said methylene donor compound (g) and said methylene acceptor compound (h) may also be added to the crosslinkable elastomeric composition in the precondensed form (condensed before being added to said crosslinkable elastomeric composition) such as, for example, resorcinol-formaldeyde resin; substituted melamine resins such as, for example, N-substituted oxymethylmelamine resins; or mixtures thereof. Said precondensed resins are able to self-crosslink as they contain different reactive groups.

As disclosed above, said crosslinkable elastomeric composition may further comprise (i) discontinuous fibres.

According to one preferred embodiment, said discontinuous fibres (i) are aramid fibres, in particular short fibrillated poly(para-phenyleneterephthalamide) fibres (also known as aramid pulp), of the type known commercially as Kevlar® pulp from Du Pont or Twaron® pulp from Teijin Twaron. Aramid fibres of the type mentioned above are disclosed, for example, in U.S. Pat. No. 4,871,004. Preferably, the aramid fibres used according to the present invention have a configuration with a main trunk with a length (L) of from 0.2 mm to 0.5 mm, a diameter (D) of from 0.005 mm to 0.02 mm and an aspect ratio L/D of from 10 to 1000, and a plurality of fibrils or small branches which extend outwards from said trunk over the entire length of the trunk and which have a diameter that is substantially smaller than the diameter of said trunk. The surface area of said fibres is of from 4 m²/g to 20 m²/g. The surface area of the aramid fibres according to the present invention is of from 30 to 60 times greater than that of fibres having the same diameter but not comprising fibrils.

According to a preferred embodiment, the abovementioned aramid fibres may be used either as such or in the form of a predispersion in a suitable polymer matrix which serves as a vehicle, consisting of, for example, natural rubber, butadiene/styrene copolymers, ethylene/vinyl acetate copolymers, or mixtures thereof. Preferably, a blend (“masterbatch”) in which the abovementioned fibres are dispersed in natural rubber, which is known by the trade name Kevlar® Engineered Elastomer from Du Pont and which is composed of 23% by weight of Kevlar® and 77% by weight of natural rubber, is used.

It should be pointed out that although the discontinuous fibres that are preferred according to the present invention are selected from the aramid fibres described above, said discontinuous fibres may also be selected from: fibres based on other polyamides (for example, nylon), on polyesters, on polyolefins, on polyvinyl alcohol; glass fibres; or natural fibres such as, for example, cellulose or lignine; or mixtures thereof.

According to one preferred embodiment, the discontinuous fibres are present in the crosslinkable elastomeric composition in an amount of from 0 phr to 10 phr, preferably of from 0.5 phr to 6 phr.

At least one additional reinforcing filler may advantageously be added to the above reported crosslinkable elastomeric composition, in an amount generally of from 0 phr to 120 phr, preferably of from 20 phr to 90 phr. The reinforcing filler may be selected from those commonly used for crosslinked manufactured articles, in particular for tires, such as, for example, silica, alumina, aluminosilicates, calcium carbonate, kaolin, or mixtures thereof.

The silica which may be used in the present invention may generally be a pyrogenic silica or, preferably, a precipitated silica, with a BET surface area (measured according to ISO standard 5794/1) of from 50 m²/g to 500 m²/g, preferably of from 70 m²/g to 200 m²/g.

When a reinforcing filler comprising silica is present, the crosslinkable elastomeric composition may advantageously incorporate a further silane coupling agent capable of interacting with silica and of linking it to the elastomeric polymers during the vulcanization. Examples of silane coupling agents which may be used have been already disclosed above.

The crosslinkable elastomeric composition above reported may be vulcanized according to known techniques, in particular with sulfur-based vulcanizing systems commonly used for elastomeric polymers. To this end, in the crosslinkable elastomeric composition, after one or more steps of thermomechanical processing, a sulfur-based vulcanizing agent is incorporated together with vulcanization accelerators. In the final processing step, the temperature is generally kept below 140° C., so as to avoid any unwanted pre-crosslinking phenomena.

The vulcanizing agent most advantageously used is sulfur, or molecules containing sulfur (sulfur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected from: dithiocarbamates, guanidine, thiourea, thiazoles, sulphenamides, thiurams, amines, xanthates, or mixtures thereof.

Said crosslinkable elastomeric composition may comprise other commonly used additives selected on the basis of the specific application for which the composition is intended. For example, the following may be added to said crosslinkable elastomeric composition: antioxidants, anti-ageing agents, plasticizers, adhesives, anti-ozone agents, modifying resins, or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to said crosslinkable elastomeric composition. The amount of plasticizer generally ranges of from 0 phr to 70 phr, preferably of from of 5 phr to 30 phr.

The above reported crosslinkable elastomeric composition may be prepared by mixing together the elastomeric base components and the layered material or a masterbatch thereof, with the reinforcing filler and the other additives optionally present, according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss), or of co-rotating or counter-rotating twin-screw type.

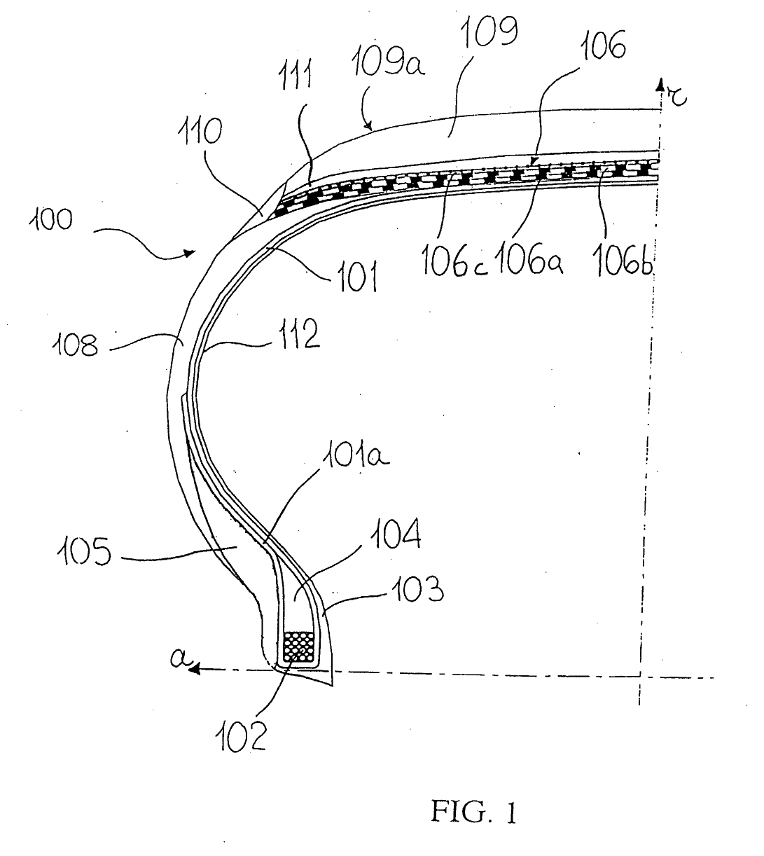

The present invention will now be illustrated in further detail by means of a number of illustrative embodiments, with reference to the attached FIG. 1-4 which are a view in cross section of a portion of a tire made according to the invention.

“a” indicates an axial direction and “r” indicates a radial direction. For simplicity, FIG. 1 shows only a portion of the tire, the remaining portion not represented being identical and symmetrically arranged with respect to the radial direction “r”.

The tire (100) comprises at least one carcass ply (101), the opposite lateral edges of which are associated with respective bead structures comprising at least one bead core (102) and at least one bead filler (104). The association between the carcass ply (101) and the bead core (102) is achieved here by folding back the opposite lateral edges of the carcass ply (101) around the bead core (102) so as to form the so-called carcass back-fold (101a) as shown in FIG. 1.

Alternatively, the conventional bead core (102) may be replaced with at least one annular insert formed from rubberized wires arranged in concentric coils (not represented in FIG. 1) (see, for example, European Patent Applications EP 928,680 or EP 928,702, both in the name of the Applicant). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of a crosslinked elastomeric composition. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. The core (102) is enclosed in a bead (103), defined along an inner circumferential edge of the tire (100), with which the tire engages on a rim (not represented in FIG. 1) forming part of a vehicle wheel. The space defined by each carcass back-fold (101a) contains a bead filler (104) which may be made according to the present invention, wherein the bead core (102) is embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of a crosslinked elastomeric composition.

A side wall (108) is also applied externally onto the carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109) has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A tread underlayer (111), which may be made according to the present invention, is placed between the belt structure (106) and the tread band (109).

As represented in FIG. 1, the tread underlayer (111) may have uniform thickness.

Alternatively, the tread underlayer (111) may have a variable thickness in the transversal direction. For example, the thickness may be greater near its outer edges than at a central zone.

In FIG. 1, said tread underlayer (111) extends over a surface substantially corresponding to the surface of development of said belt structure (106). Alternatively, said tread underlayer (111) extends only along at least one portion of the development of said belt structure (106), for instance at opposite side portions of said belt structure (106) (not represented in FIG. 1).

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109).

In the case of tubeless tires, a rubber layer (112) generally known as a liner, which provides the necessary impermeability to the inflation air of the tire, may also be provided in an inner position relative to the carcass ply (101).

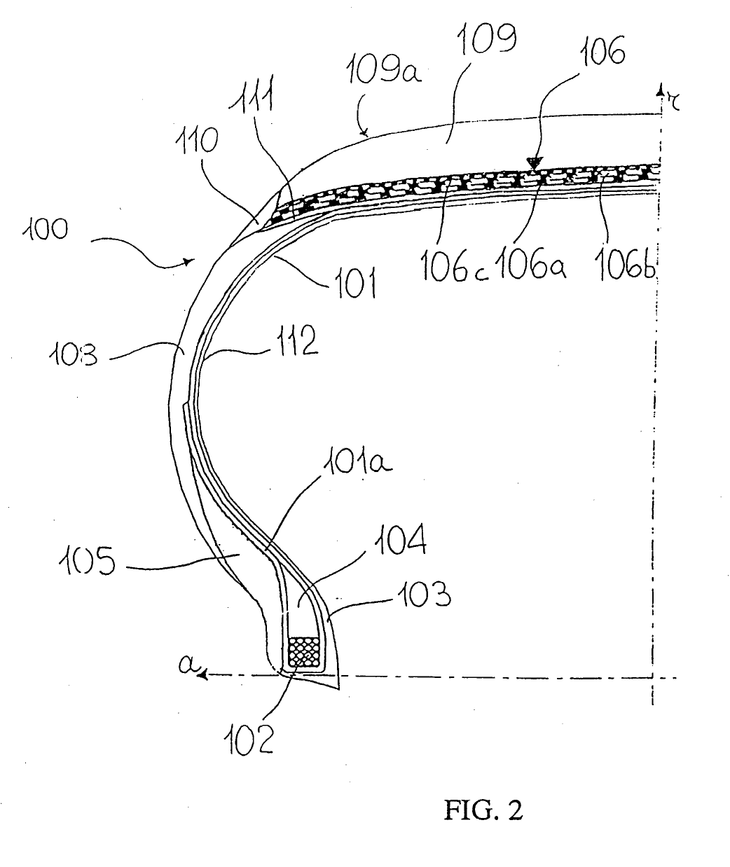

FIG. 2, shows a tire (100) having a structure as described in FIG. 1 where the tread underlayer (111), which may be made according to the present invention, is placed between the belt structure (106) and the carcass ply (101).

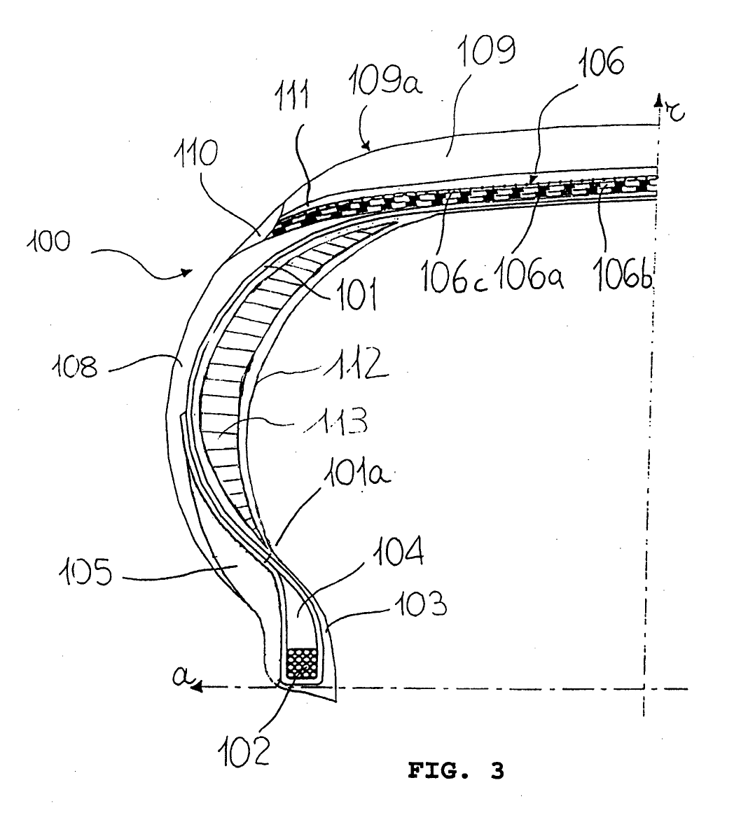

FIG. 3, shows a tire (100) having a structure as described in FIG. 1 where a sidewall insert (113), which may be made according to the present invention, which extends radially from a position corresponding to the bead structure to a position corresponding to a tread lateral edge, is placed in an axially internal position with respect to the carcass ply: for example, as represented in FIG. 3, said sidewall insert is placed between the carcass ply (101) and the liner (112). Alternatively, in the case in which more carcass plies are present, a sidewall insert (113) may be placed between two of said carcass plies (not represented in FIG. 3.) Alternatively, a sidewall insert may be placed between the carcass ply and the side wall (not represent in FIG. 3). More than one sidewall insert may be present as disclosed, for example, in U.S. Pat. No. 5,238,040 or in European Patent EP 943,466.

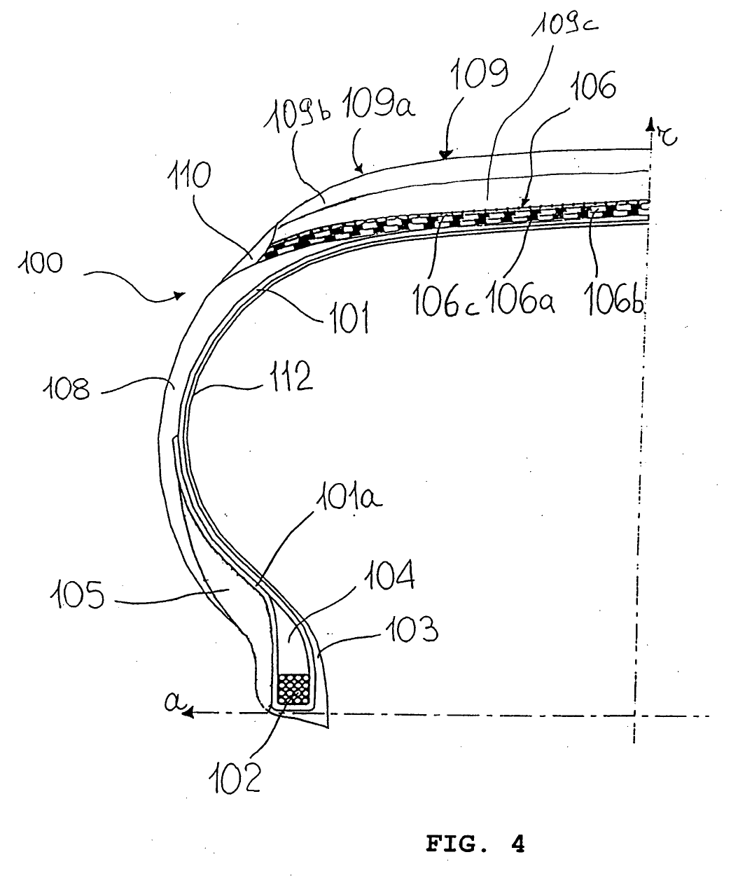

FIG. 4, shows a tire (100) having a structure as described in FIG. 1 where a tread band (109) is of cap and base construction. More in particular, said tread band (109) comprises a radially inner layer or tread base (109c) and a radially outer layer or tread cap (109b): the tread base (109c) may be made according to the present invention.

As represented in FIG. 4, the tread base (109c) has a uniform thickness. In any case, the thickness of the tread base (109c) may also be not uniform but, for example, greater near its outer edges and/or at the central zone thereof.

The process for producing the tire according to the present invention may be carried out according to techniques and using apparatus that are known in the art, as described, for example, in European Patents EP 199,064, or in U.S. Pat. No. 4,872,822 or U.S. Pat. No. 4,768,937, said process including at least one stage of manufacturing the crude tire and at least one stage of vulcanizing this tire.

More particularly, the process for producing the tire comprises the steps of preparing, beforehand and separately from each other, a series of semi-finished products corresponding to the various structural elements of the tire (carcass plies, belt structure, bead wires, fillers, sidewalls and tread band) which are then combined together using a suitable manufacturing machine. Next, the subsequent vulcanization step welds the abovementioned semi-finished products together to give a monolithic block, i.e. the finished tire.

The step of preparing the abovementioned semi-finished products will be preceded by a step of preparing and moulding the various crosslikable elastomeric compositions, of which said semi-finished products are made, according to conventional techniques.

The crude tire thus obtained is then passed to the subsequent steps of moulding and vulcanization. To this end, a vulcanization mould is used which is designed to receive the tire being processed inside a moulding cavity having walls which are countermoulded to define the outer surface of the tire when the vulcanization is complete.

Alternative processes for producing a tire or parts of a tire without using semi-finished products are disclosed, for example, in the abovementioned European Patent Applications EP 928,680 or EP 928,702.

According to one preferred embodiment, said structural elements are formed by a plurality of coils of a continuous elongated element. Said elongated element may be produced, for example, by extruding the crosslinkable elastomeric composition above disclosed. Preferably, said structural elements are assembled onto a support.

For the purposes of the present description and of the claims which follow, the term “support” is used to indicate the following devices:
an auxiliary drum having a cylindrical shape, said auxiliary drum preferably supporting a belt structure;
a shaping drum having a substantially toroidal configuration, said shaping drum preferably supporting at least one carcass structure with a belt structure assembled thereon;
a rigid support preferably shaped according to the inner configuration of the tire.

Further details regarding said devices and the methods of forming and/or depositing the structural elements of the tire on a support are described, for example, in International Patent Application WO 01/36185 or in European Patent EP 976,536, both in the name of the Applicant, or in European Patent Applications: EP 968,814, EP 1,201,414 or EP 1,211,057.

The crude tire can be moulded by introducing a pressurized fluid into the space defined by the inner surface of the tire, so as to press the outer surface of the crude tire against the walls of the moulding cavity. In one of the moulding methods widely practised, a vulcanization chamber made of elastomeric material, filled with steam and/or another fluid under pressure, is inflated inside the tire closed inside the moulding cavity. In this way, the crude tire is pushed against the inner walls of the moulding cavity, thus obtaining the desired moulding. Alternatively, the moulding may be carried out without an inflatable vulcanization chamber, by providing inside the tire a toroidal metal support shaped according to the configuration of the inner surface of the tire to be obtained as described, for example, in European Patent EP 1,189,744.

At this point, the step of vulcanizing the crude tire is carried out. To this end, the outer wall of the vulcanization mould is placed in contact with a heating fluid (generally steam) such that the outer wall reaches a maximum temperature generally of from 100° C. to 230° C. Simultaneously, the inner surface of the tire is heated to the vulcanization temperature using the same pressurized fluid used to press the tire against the walls of the moulding cavity, heated to a maximum temperature of from 100° C. to 250° C. The time required to obtain a satisfactory degree of vulcanization throughout the mass of the elastomeric material may vary in general of from 3 min to 90 min and depends mainly on the dimensions of the tire. When the vulcanization is complete, the tire is removed from the vulcanization mould.

The present invention will be further illustrated below by means of, a number of preparation examples, which are given for purely indicative purposes and without any limitation of this invention.

### EXAMPLES 1-4

### Preparation of the Elastomeric Compositions

The elastomeric compositions given in Table 1 were prepared as follows (the amounts of the various components are given in phr).

All the components, except sulfur, retardant (PVI) and accelerator (DCBS), were mixed together in an internal mixer (model Pomini PL 1.6) for about 5 min (1^{st} Step). As soon as the temperature reached 145±5° C., the elastomeric material was discharged. The sulfur, retardant (PVI) and accelerator (DCBS), were then added and mixing was carried out in an open roll mixer (2^{nd} Step).

TABLE 1

| | | | | |
|---|---|---|---|---|
| EXAMPLE | 1 (*) | 2 (*) | 3 (*) | 4 |

1^{st} STEP

| | | | | |
|---|---|---|---|---|
| NR | 100 | 100 | 100 | 100 |
| Dellite ® 67G | 30 | 30 | 30 | 30 |
| N326 | 50 | 50 | 50 | 50 |
| Phthalic anhydride | — | — | 1.7 | 1.7 |
| TESPD | 2.0 | 2.0 | 2.0 | 2.0 |
| Antioxidant | 2.0 | 2.0 | 2.0 | 2.0 |
| ZnO | 7.0 | 7.0 | 7.0 | 7.0 |
| Stearic acid | 2.0 | 2.0 | 2.0 | 2.0 |

2^{nd} STEP

| | | | | |
|---|---|---|---|---|
| Sulfur | 3.0 | 3.0 | 3.0 | 3.0 |
| PVI | — | 0.4 | — | 0.4 |
| DCBS | 1.3 | 1.3 | 1.3 | 1.3 |

(*) comparative.
NR: natural rubber;
Dellite ® 67G: montmorillonite belonging to the smectite family modified with quaternary ammonium salt (Laviosa Chimica Mineraria S.p.A.);
N326: carbon black;
TESPD: bis(3-triethoxysilylpropyl)disulphide (Degussa-Hüls);
Antioxidant: phenyl-p-phenylenediamine;
PVI (retardant): N-cyclohexylthiophthalimide (Santogard ® PVI - Flexys);
DCBS (accelerator): benzothiazyl-2-dicyclohexyl-sulfenamide (Vulkacit ® DZ/EGC - Lanxess).

The crosslinkable elastomeric compositions disclosed above were subjected to “scorch time” measurement, at 127° C., according to Standard ISO 289-2:1994.

The static mechanical properties according to Standard ISO 37:1994 (ring procedure) as well as hardness in IRHD degrees (at 23° C. and at 100° C.) according to ISO standard 48:1994, were measured on samples of the abovementioned elastomeric compositions vulcanized at 170° C. for 10 min. The results obtained are given in Table 2.

Table 2 also shows the dynamic mechanical properties, measured using an Instron dynamic device in the traction-compression mode according to the following methods. A test piece of the crosslinked elastomeric composition (vulcanized at 170° C. for 10 min) having a cylindrical form (length=25 mm; diameter=12 mm), compression-preloaded up to a 10% longitudinal deformation with respect to the initial length, and kept at the prefixed temperature (70° C.) for the whole duration of the test, was submitted to a dynamic sinusoidal strain having an amplitude of ±2.2% with respect to the length under pre-load, with a 100 Hz frequency. The dynamic mechanical properties are expressed in terms of dynamic elastic modulus (E′) and Tan delta (loss factor) values. The Tan delta value is calculated as a ratio between viscous modulus (E″) and elastic modulus (E′).

Said crosslinkable elastomeric compositions were also subjected to MDR rheometric analysis using a Monsanto MDR rheometer, the tests being carried out at 170° C. for 20 minutes at an oscillation frequency of 1.66 Hz (100 oscillations per minute) and an oscillation amplitude of ±0.50. The results obtained are given in Table 2.

TABLE 2

| EXAMPLE | 1 (*) | 2 (*) | 3 (*) | 4 |
|---|---|---|---|---|
| Scorch time | 5.22 | 8.17 | 10.42 | 22.18 |
| (min) | | | | |

STATIC MECHANICAL PROPERTIES

| | | | | |
|---|---|---|---|---|
| 50% Modulus | 3.37 | 3.59 | 4.44 | 4.23 |
| 100% Modulus | 6.00 | 6.32 | 7.27 | 6.87 |
| Stress at break | 19.20 | 19.19 | 19.37 | 19.35 |
| (MPa) | | | | |
| Elongation at | 397.1 | 390.4 | 384.4 | 398.8 |
| break | | | | |

DYNAMIC MECHANICAL PROPERTIES

| | | | | |
|---|---|---|---|---|
| E′ (70° C.) | 11.46 | 13.56 | 17.28 | 17.17 |
| Tandelta (70° C.) | 0.209 | 0.191 | 0.228 | 0.233 |
| IRHD Hardness | 82.6 | 83.9 | 88.8 | 89.4 |
| (23° C.) | | | | |
| IRHD Hardness | 68.9 | 70.9 | 75.2 | 74.7 |
| (70° C.) | | | | |

MDR RHEOMETRIC ANALYSIS (20 min, 170° C.)

| | | | | |
|---|---|---|---|---|
| ML (dN · m) | 1.71 | 1.47 | 1.71 | 1.57 |
| MH (dN · m) | 14.17 | 15.05 | 22.98 | 23.16 |
| T30 | 0.49 | 0.53 | 1.08 | 1.43 |
| T60 | 0.77 | 0.77 | 2.19 | 2.52 |
| T90 | 1.43 | 1.30 | 4.31 | 4.60 |

(*) comparative.

### EXAMPLES 5-11

### Preparation of the Elastomeric Compositions

The elastomeric compositions given in Table 3 were prepared as follows (the amounts of the various components are given in phr).

All the components, except sulfur, retardant (PVI), accelerator (DCBS) and hexamethoxymethylmelamine (HMMM), were mixed together in an internal mixer (model Pomini PL 1.6) for about 5 min (1^{st} Step). As soon as the temperature reached 145±5° C., the elastomeric material was discharged. The sulfur, retardant (PVI), accelerator (DCBS) and hexamethoxymethylmelamine (HMMM), were then added and mixing was carried out in an open roll mixer (2^{nd} Step).

TABLE 3

| | | | | | | | |
|---|---|---|---|---|---|---|---|
| EXAMPLE | 5 (*) | 6 (*) | 7 (*) | 8 (*) | 9 (*) | 10 | 11 |

1^{st} STEP

| | | | | | | | |
|---|---|---|---|---|---|---|---|
| NR | 100 | 100 | 100 | 100 | 100 | 100 | 100 |
| Dellite ® 67G | 42.4 | 42.4 | 42.4 | 42.4 | 42.4 | 42.4 | 42.4 |
| N326 | 55.0 | 55.0 | 55.0 | 55.0 | 55.0 | 55.0 | 55.0 |
| Phthalic anhydride | — | — | — | 0.85 | 1.70 | 0.85 | 1.70 |
| TESPD | 4.24 | 4.24 | 4.24 | 4.24 | 4.24 | 4.24 | 4.24 |
| Resorcinol | 1.27 | 1.27 | 1.27 | 1.27 | 1.27 | 1.27 | 1.27 |
| Antioxidant | 1.70 | 1.70 | 1.70 | 1.70 | 1.70 | 1.70 | 1.70 |
| ZnO | 6.78 | 6.78 | 6.78 | 6.78 | 6.78 | 6.78 | 6.78 |
| Stearic acid | 1.70 | 1.70 | 1.70 | 1.70 | 1.70 | 1.70 | 1.70 |

2^{nd} STEP

| | | | | | | | |
|---|---|---|---|---|---|---|---|
| Sulfur | 2.97 | 2.97 | 2.97 | 2.97 | 2.97 | 2.97 | 2.97 |
| PVI | — | 0.20 | 0.40 | — | — | 0.20 | 0.40 |
| DCBS | 1.27 | 1.27 | 1.27 | 1.27 | 1.27 | 1.27 | 1.27 |
| HMMM | 2.75 | 2.75 | 2.75 | 2.75 | 2.75 | 2.75 | 2.75 |

(*) comparative.
NR: natural rubber;
Dellite ® 67G: montmorillonite belonging to the smectite family modified with quaternary ammonium salt (Laviosa Chimica Mineraria S.p.A.);
N326: carbon black;
TESPD: bis(3-triethoxysilylpropyl)disulphide (Degussa-Hüls);
Antioxidant: phenyl-p-phenylenediamine;
PVI (retardant): N-cyclohexylthiophthalimide (Santogard ® PVI - Flexys);
DCBS (accelerator): benzothiazyl-2-dicyclohexyl-sulfenamide (Vulkacit ® DZ/EGC - Lanxess);
HMMM: hexamethoxymethylmelamine.

The crosslinkable elastomeric compositions disclosed above were subjected to “scorch time” measurement, at 127° C., according to Standard ISO 289-2:1994.

The static mechanical properties according to Standard ISO 37:1994 (dumbell 2 procedure) as well as hardness in IRHD degrees (at 23° C. and at 100° C.) according to ISO standard 48:1994, were measured on samples of the abovementioned elastomeric compositions vulcanized at 170° C. for 10 min. The results obtained are given in Table 4.

Table 4 also shows the dynamic mechanical properties, measured using an Instron dynamic device in the traction-compression mode according to the following methods. A test piece of the crosslinked elastomeric composition (vulcanized at 170° C. for 10 min) having a cylindrical form (length=25 mm; diameter=12 mm), compression-preloaded up to a 10% longitudinal deformation with respect to the initial length, and kept at the prefixed temperature (70° C.) for the whole duration of the test, was submitted to a dynamic sinusoidal strain having an amplitude of ±2.2% with respect to the length under pre-load, with a 100 Hz frequency. The dynamic mechanical properties are expressed in terms of dynamic elastic modulus (E′) and Tan delta (loss factor) values. The Tan delta value is calculated as a ratio between viscous modulus (E″) and elastic modulus (E′).

Said crosslinkable elastomeric compositions were also subjected to MDR rheometric analysis using a Monsanto. MDR rheometer, the tests being carried out at 170° C. for 20 minutes at an oscillation frequency of 1.66 Hz (100 oscillations per minute) and an oscillation amplitude of ±0.5°. The results obtained are given in Table 4.

TABLE 4

| EXAMPLE | 5 (*) | 6 (*) | 7 (*) | 8 (*) | 9 (*) | 10 | 11 |
|---|---|---|---|---|---|---|---|
| Scorch time | 5.73 | 6.87 | 8.68 | 6.87 | 9.23 | 9.58 | 17.32 |
| (min) | | | | | | | |

STATIC MECHANICAL PROPERTIES

| | | | | | | | |
|---|---|---|---|---|---|---|---|
| 50% Modulus | 8.31 | 9.29 | 8.46 | 9.95 | 8.58 | 9.44 | 8.60 |
| 100% Modulus | 13.18 | 13.86 | 13.26 | 14.13 | 12.65 | 13.69 | 12.67 |
| Stress at | 24.75 | 21.84 | 25.52 | 19.32 | 23.63 | 18.55 | 23.51 |
| break (MPa) | | | | | | | |
| Elongation at | 295.72 | 264.94 | 312.26 | 227.51 | 305.21 | 233.33 | 302.90 |
| break | | | | | | | |

DYNAMIC MECHANICAL PROPERTIES

| | | | | | | | |
|---|---|---|---|---|---|---|---|
| E′ (70° C.) | 37.86 | 41.43 | 37.40 | 48.07 | 47.45 | 50.20 | 49.54 |
| Tandelta | 0.248 | 0.266 | 0.258 | 0.269 | 0.272 | 0.273 | 0.278 |
| (70° C.) | | | | | | | |
| IRHD Hardness | 94.4 | 95.2 | 93.9 | 97.0 | 96.5 | 96.9 | 96.9 |
| (23° C.) | | | | | | | |
| IRHD Hardness | 88.0 | 88.9 | 87.7 | 91.5 | 91.0 | 92.1 | 91.4 |
| (100° C.) | | | | | | | |

MDR RHEOMETRIC ANALYSIS (20 min. 170° C.)

| | | | | | | | |
|---|---|---|---|---|---|---|---|
| ML (dN · m) | 1.98 | 2.39 | 2.03 | 2.35 | 2.16 | 2.60 | 2.23 |
| MH (dN · m) | 41.50 | 40.22 | 40.33 | 47.83 | 49.55 | 46.15 | 50.18 |
| T30 | 0.91 | 0.81 | 0.89 | 1.10 | 1.41 | 1.06 | 1.55 |
| T60 | 2.10 | 2.00 | 2.04 | 2.30 | 2.66 | 2.19 | 2.81 |
| T90 | 6.19 | 5.95 | 6.12 | 5.61 | 5.47 | 5.40 | 5.64 |

(*) comparative.

1-71. (canceled)

72. A tire comprising at least one structural element comprising a crosslinked elastomeric material obtained by crosslinking a crosslinkable elastomeric composition comprising:
(a) 100 phr of at least one diene elastomeric polymer;
(b) 5 phr to 120 phr of at least one layered material modified with at least one alkyl ammonium or alkyl phosphonium salt, said layered material having an individual layer thickness of 0.01 nm to 30 nm;
(c) 0.05 phr to 2 phr of at least one N-acyl-sulfenyl amide; and
(d) 0.3 phr to 5 phr of at least one organic or inorganic acid or a derivative thereof selected from: carboxylic acids, phosphoric acids, sulfonic acids, boric acids, or derivatives thereof.

73. The tire according to claim 72, wherein said crosslinkable elastomeric composition comprises 10 phr to 80 phr of at least one layered material modified with at least one alkyl ammonium or alkyl phosphonium salt (b).

74. The tire according to claim 73, wherein said crosslinkable elastomeric composition comprises 20 phr to 50 hr of at least one layered material modified with at least one alkyl ammonium or alkyl phosphonium salt (b).

75. The tire according to claim 72, wherein said at least one layered material modified with at least one alkyl ammonium or alkyl phosphonium salt (b) has an individual layer thickness of 0.05 nm to 15 nm.

76. The tire according to claim 75, wherein said at least one layered material modified with at least one alkyl ammonium or alkyl phosphonium salt (b) has an individual layer thickness of 0.1 nm to 2 nm.

77. The tire according to claim 72, wherein said crosslinkable elastomeric composition comprises 0.1 phr to 1 phr of at least one N-acyl-sulfenyl amide (c).

78. The tire according to claim 77, wherein said crosslinkable elastomeric composition comprises 0.2 phr to 0.5 phr of at least one N-acyl-sulfenyl amide (c).

79. The tire according to claim 72, wherein said crosslinkable elastomeric composition comprises 0.5 phr to 4 phr of at least one organic or inorganic acid or a derivative thereof (d).

80. The tire according to claim 79, wherein said crosslinkable elastomeric composition comprises 0.7 phr to 2 phr of at least one organic or inorganic acid or a derivative thereof (d).

81. The tire according to claim 72, comprising:
a carcass structure of a substantially toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure;
at least one structural element selected from bead filler, sidewall insert, tread underlayer, and tread base, obtained by crosslinking a crosslinkable elastomeric composition comprising:
(a) 100 phr of at least one diene elastomeric polymer;
(b) 5 phr to 120 phr of at least one layered material modified with at least one alkyl ammonium or alkyl phosphonium salt, said layered material having an individual layer thickness of 0.01 nm to 30 nm;
(c) 0.05 phr to 2 phr of at least one N-acyl-sulfenyl amide; and
(d) 0.3 phr to 5 phr of at least one organic or inorganic acid or a derivative thereof selected from: carboxylic acids, phosphoric acids, sulfonic acids, boric acids, or derivatives thereof.

82. The tire according to claim 81, wherein said crosslinkable elastomeric composition comprises:
phr to 80 phr of at least one layered material modified with at least one alkyl ammonium or alkyl phosphonium salt (b); or
at least one layered material modified with at least one alkyl ammonium or alkyl phosphonium salt (b) having an individual layer thickness of from 0.05 nm to 15 nm; or
0.1 phr to 1 phr of at least one N-acyl-sulfenyl amide (c); or
0.05 phr to 4 phr of at least one organic or inorganic acid or a derivative thereof (d).

83. The tire according to claim 81, wherein said sidewall insert extends radially from a position corresponding to the bead structure to a position corresponding to a tread lateral edge.

84. The tire according to claim 81, wherein said tread underlayer is a layer of a crosslinked elastomeric material applied in a radially inner position with respect to said tread band.

85. The tire according to claim 81, wherein said tread band is of cap and base construction and comprises a radially inner layer or tread base and a radially outer layer or tread cap.

86. The tire according to claim 72, wherein said structural element has a dynamic elastic modulus, measured at 70° C., not lower than 10 MPa.

87. The tire according to claim 86, wherein said structural element has a dynamic elastic modulus, measured at 70° C., of 15 MPa to 80 MPa.

88. The tire according to claim 72, wherein said structural element has a tensile modulus at 100% elongation not lower than 4 MPa.

89. The tire according to claim 88, wherein said structural element has a tensile modulus at 100% elongation of 5 MPa to 20 MPa.

90. The tire according to claim 72, wherein said structural element has an IRHD hardness, measured at 23° C., not lower than 70.

91. The tire according to claim 90, wherein said structural element has an IRHD hardness, measured at 23° C., of 80 to 98.

92. The tire according to claim 72, wherein said diene elastomeric polymer (a) has a glass transition temperature below 20° C.

93. The tire according to claim 92, wherein said diene elastomeric polymer (a) is selected from: natural or synthetic cis-1,4-polyisoprene, 3,4-polyisoprene, polybutadiene, halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

94. The tire according to claim 72, wherein said crosslinkable elastomeric composition comprises at least 10% by weight with respect to the total weight of the at least one diene elastomeric polymer (a) of natural or synthetic cis-1,4-polyisoprene.

95. The tire according to claim 94, wherein said crosslinkable elastomeric composition comprises 20% by weight to 100% by weight with respect to the total weight of the at least one diene elastomeric polymer (a) of natural or synthetic cis-1,4-polyisoprene.

96. The tire according to claim 72, wherein said crosslinkable elastomeric composition further comprises at least one elastomeric polymer of one or more monoolefins with an olefinic comonomer or derivatives thereof (a′).

97. The tire according to claim 96, wherein said elastomeric polymer (a′) is selected from: ethylene/propylene copolymers or ethylene/propylene/diene copolymers; polyisobutene; butyl rubbers; halobutyl rubbers; or mixtures thereof.

98. The tire according to claim 72, wherein said layered material modified with at least one alkyl ammonium or alkyl phosphonium salt (b) is selected from the following compounds: phyllosilicates, smectites, montmorillonite, bentonite, nontronite, beidellite, volkonskoite, hectorite, saponite, sauconite; vermiculite; halloisite; sericite; aluminate oxides; hydrotalcite; or mixtures thereof; said compounds being modified with at least one alkyl ammonium or alkyl phosphonium salt.

99. The tire according to claim 72, wherein said alkyl ammonium or alkyl phosphonium salt is selected from quaternary ammonium or phosphonium salts having general formula (I): 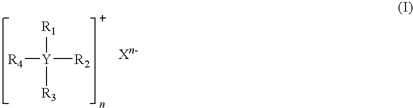
wherein:
Y represents N or P;
R₁, R₂, R₃ and R₄, which may be the same or different from each other, represent a linear or branched C₁-C₂₀ alkyl or hydroxyalkyl group; a linear or branched C₁-C₂₀ alkenyl or hydroxyalkenyl group; an —R₅—SH or —R₅—NH group, wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, or a C₅-C₁₈ cycloalkyl group containing a hetero atom, an oxygen atom, a nitrogen atom, or a sulfur atom;
Xⁿ⁻ represents an anion, a chloride ion, a sulphate ion or a phosphate ion; and
n represents 1, 2 or 3.

100. The tire according to claim 72, wherein said N-acyl-sulphenyl amide (c) is selected from compounds having general formula (II): 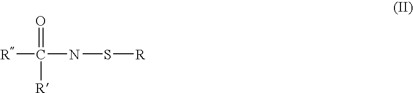
wherein:
R represents a linear or a branched C₁-C₂₀ alkyl group; or a C₅-C₁₈ cycloalkyl group;
R′ represents a hydrogen atom; a linear or branched C₁-C₂₀ alkyl group; a C₆-C₁₈ aryl group; a C₇-C₂₀ arylalkyl or alkylaryl group; or, R′ and R, considered jointly together with the nitrogen atom and the sulfur atom to which they are linked, represent a saturated or unsaturated C₃-C₁₀ heterocyclic ring;
R″ represents a hydrogen atom; a linear or branched C₁-C₂₀ alkyl group; a C₆-C₁₈ aryl group; a C₇-C₂₀ arylalkyl or alkylaryl group; a —(CH₂)ₙ—CO—NR′—SR group, wherein n is an integer of from 1 to 20, extremes included, and R′ and R are defined above; an —Ar—CO—NR′—SR group, wherein Ar represents a C₆-C₁₈ arylidene group, and R′ and R are defined above; an —Ar—CRₐ═CR_{b}—Ar—CO—NR′—SR group, wherein Ar is defined above, Rₐ and R_{b}, which may be the same or different from each other, represent a hydrogen atom, a linear or branched C₁-C₂₀ alkyl group, and R′ and R are defined above; a R_{c}—NH— group or a (R_{c})₂—N— group, wherein the R_{c} groups, which may be the same or different from each other, represent a linear or branched C₁-C₂₀ alkyl group; a R_{d}—CONH— group or a R_{d}—CON—Rₑ— group, wherein R_{d} and Rₑ, which may be the same or different from each other, represent a linear or branched C₁-C₂₀ alkyl group; or, R″ and R′, considered jointly together with the nitrogen atom and the carbon atom to which they are linked, represent a saturated or unsaturated C₃-C₁₀ heterocyclic ring.

101. The tire according to claim 100, wherein said N-acyl-sulphenyl amide (c) is N-cyclohexylthiophthalimide.

102. The tire according to claim 72, wherein said carboxylic acids are selected from: maleic acid; fumaric acid; citraconic acid; itaconic acid; acrylic acid; methacrylic acid; butanoic acid; pentanoic acid; hexanoic acid; heptanoic acid; octanoic acid; phthalic acid; salicylic acid; benzoic acid; sulfur containing carboxylic acids, thiodipropionic acid, dithiodipropionic acid; or mixtures thereof.

103. The tire according to claim 72, wherein said phosphoric acids are selected from: metaphosphoric acid; triphosphoric acid; pyrophosphoric acid; alkyl phosphoric acids, di-2-ethylhexyl phosphoric acid, mono-dodecyl phosphoric acid; aryl or alkylaryl phosphoric acids, phenyl phosphoric acid, tolyl phosphoric acid, xylyl phosphoric acid, octylphenyl phosphoric acid; or mixtures thereof.

104. The tire according to claim 72, wherein said sulfonic acids are selected from: alkyl sulfonic acids, methanesulfonic acid, ethanesulfonic acid, propane sulfonic acid, 2-butane sulfonic acid; aryl or alkylaryl sulfonic acids, toluenesulfonic acid, p-dodecylfulfonic acid, tetra-propylbenzenesulfonic acid, acetyl p-dodecylsulfonic acid, 1-naphthalenesulfonic acid, 2-naphthalene sulfonic acid; or mixtures thereof.

105. The tire according to claim 72, wherein said boric acids are selected from: metaboric acid; pyroboric acid; alkyl boric acids, methylboric acid, ethylboric acid, butylboric acid; aryl boric acids, phenylboric acid; or mixtures thereof.

106. The tire according to claim 72, wherein said derivative of the organic or inorganic acid is selected from; esters, anhydrides, halides, imides, amides, or mixtures thereof.

107. The tire according to claim 72, wherein said organic or inorganic acid or a derivative thereof (d) is phthalic anhydride.

108. The tire according to claim 72, wherein said crosslinkable elastomeric composition further comprises 0 phr to 120 phr of at least one carbon black reinforcing filler (e)

109. The tire according to claim 108, wherein said crosslinkable elastomeric composition further comprises 20 phr to 90 phr of at least one carbon black reinforcing filler (e).

110. The tire according to claim 72, wherein said crosslinkable elastomeric composition further comprises 0 phr to 10 phr of at least one silane coupling agent (f).

111. The tire according to claim 110, wherein said crosslinkable elastomeric composition further comprises 0.5 phr to 5 phr of at least one silane coupling agent (f).

112. The tire according to claim 110, wherein said silane coupling agent is selected from a silane having at least one hydrolizable silane group which may be identified by the following general formula (III):
(R₅)₃Si—CₙH₂ₙ—X (III)
wherein the R₅ groups, which may be the same or different from each other, are selected from: alkyl, alkoxy or aryloxy groups or from halogen atoms, on condition that at least one of the R₅ groups is an alkoxy or aryloxy group; n is an integer of from 1 to 6, extremes included; X is a group selected from: nitroso, mercapto, amino, epoxide, vinyl, imide, chloro, —(S)ₘCₙH₂ₙ—Si—(R₅)₃, or —S—COR₅, in which m and n are integers of from 1 to 6, extremes included and the R₅ groups are defined as above.

113. The tire according to claim 72, wherein said crosslinkable elastomeric composition further comprises 0 phr to 15 phr of at least one methylene donor compound (g).

114. The tire according to claim 113, wherein said crosslinkable elastomeric composition further comprises 0.1 phr to 10 phr of at least one methylene donor compound (g).

115. The tire according to claim 113, wherein said methylene donor compound (g) is selected from: hexamethylenetetramine; hexamethoxymethylmelamine; formaldehyde; paraformaldehyde; trioxane; 2-methyl-2-nitro-1-propanal; substituted melamine resins, N-substituted oxymethylmelamine resins; glycoluril compounds, tetramethoxymethyl glycoluril; and urea-formaldehyde resins, butylated urea-formaldehyde resins; or mixtures thereof.

116. The tire according to claim 72 wherein said crosslinkable elastomeric composition further comprises 0 phr to 20 phr of at least one methylene acceptor compound (h).

117. The tire according to claim 116, wherein said crosslinkable elastomeric composition further comprises 0.4 phr to 15 phr of at least one methylene acceptor compound (h).

118. The tire according to claim 116, wherein said methylene acceptor compound (h) is selected from: resorcinol; catechol; hydroquinone; pyrogallol; phloroglucinol; 1-naphthol; 2-naphthol; phenolic resins obtained from the condensation of a substituted phenol, a phenol substituted with an aldehyde, formaldehyde, acetaldehyde, and furfural; or mixtures thereof.

119. The tire according to claim 72, wherein said crosslinkable elastomeric composition further comprises 0 phr to 10 phr of discontinuous fibres (i).

120. The tire according to claim 119, wherein said crosslinkable elastomeric composition further comprises 0.5 phr to 6 phr of discontinuous fibres (i).

121. The tire according to claim 119, wherein said discontinuous fibres (i) are aramid fibres.

122. The tire according to claim 121, wherein said aramid fibres are short fibrillated poly(paraphenylene-terephthalamide) fibres.

123. The tire according to claim 121, wherein said aramid fibres are predispersed in a polymer matrix selected from: natural rubber, butadiene/styrene copolymers, and ethylene/vinyl acetate copolymers.

124. The tire according to claim 119, wherein said discontinuous fibres (i) are selected from: fibres based on polyamides, on polyesters, on polyolefins, on polyvinyl alcohol; glass fibres; natural fibres, cellulose, lignine; or mixtures thereof.

125. The tire according to claim 72, wherein at least one additional reinforcing filler is present in said crosslinkable elastomeric composition in an amount of 0 phr to 120 phr.

126. The tire according to claim 125, wherein said additional reinforcing filler is silica.

127. The tire according to claim 126, further comprising at least one silane coupling agent (d) selected from a silane having at least one hydrolizable silane group which may be identified by the following general formula (III):
(R₅)₃Si—CₙH₂ₙ—X (III)
wherein the R₅ groups, which may be the same or different from each other, are selected from: alkyl, alkoxy or aryloxy groups or from halogen atoms, on condition that at least one of the R₅ groups is an alkoxy or aryloxy group; n is an integer of from 1 to 6, extremes included; X is a group selected from: nitroso, mercapto, amino, epoxide, vinyl, imide, chloro, —(S)ₘCₙH₂ₙ—Si—(R₅)₃, or —S—COR₅, in which m and n are integers of from 1 to 6, extremes included, and the R₅ groups are defined as above.

128. A crosslinkable elastomeric composition comprising:
(a) 100 phr of at least one diene elastomeric polymer;
(b) 5 phr to 120 phr of at least one layered material modified with at least one alkyl ammonium or alkyl phosphonium salt, said layered material having an individual layer thickness of from 0.01 nm to 30 nm;
(c) 0.05 phr to 2 phr of at least one N-acyl-sulfenyl amide;
(d) 0.3 phr to 5 phr of at least one organic or inorganic acid or a derivative thereof selected from: carboxylic acids, phosphoric acids, sulfonic acids, boric acids, or derivatives thereof.

129. The crosslinkable elastomeric composition according to claim 128, comprising:
10 phr to 80 phr of at least one layered material modified with at least one alkyl ammonium or alkyl phosphonium salt (b); or
at least one layered material modified with at least one alkyl ammonium or alkyl phosphonium salt (b) having an individual layer thickness of 0.05 nm to 15 nm; or
0.1 phr to 1 phr of at least one N-acyl-sulfenyl amide (c); or
0.5 phr to 4 phr of at least one organic or inorganic acid or a derivative thereof (d).

130. The crosslinkable elastomeric composition according to claim 128, wherein said diene elastomeric polymer (a):
has a glass transition temperature below 20° C.; or
is selected from: natural or synthetic cis-1,4-polyisoprene, 3,4-polyisoprene, polybutadiene, halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof; or
comprises at least 10% by weight with respect to the total weight of the at least one diene elastomeric polymer (a) of natural or synthetic cis-1,4-polyisoprene.

131. The crosslinkable elastomeric composition according to claim 128, wherein said layered material modified with at least one alkyl ammonium or alkyl phosphonium salt (b);
is selected from the following compounds: phyllosilicates, smectites, montmorillonite, bentonite, nontronite, beidellite, volkonskoite, hectorite, saponite, sauconite; vermiculite; halloisite; sericite, aluminate oxides; hydrotalcite; or mixtures thereof, said compounds being modified with at least one alkyl ammonium or alkyl phosphonium salt; or
wherein said alkyl ammonium or alkyl phosphonium salt is selected from quaternary ammonium or phosphonium salts having general formula (I): 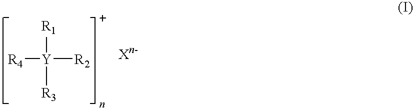
Y represents N or P;
R₁, R₂, R₃ and R₄, which may be the same or different from each other, represent a linear or branched C₁-C₂₀ alkyl or hydroxyalkyl group; a linear or branched C₁-C₂₀ alkenyl or hydroxyalkenyl group; an —R₅—SH or —R₅—NH group, wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, or a C₅-C₁₈ cycloalkyl group containing hetero atom, oxygen atom, nitrogen atom or sulfur atom;
Xⁿ⁻ represents an anion, a chloride ion, a sulphate ion or a phosphate ion; and
n represents 1, 2 or 3.

132. The crosslinkable elastomeric composition according to claim 128, wherein said N-acyl-sulfenyl amide (c):
is selected from compounds having general formula (II): 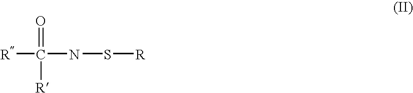
wherein:
R represents a linear or branched C₁-C₂₀ alkyl group; a C₅-C₁₈ cycloalkyl group;
R′ represents a hydrogen atom; a linear or branched C₁-C₂₀ alkyl group; a C₆-C₁₈ aryl group; a C₇-C₂₀ arylalkyl or alkylaryl group; or, R′ and R, considered jointly together with the nitrogen atom and the sulfur atom to which they are linked, represent a saturated or unsaturated C₃-C₁₀ heterocyclic ring;
R″ represents a hydrogen atom; a linear or branched C₁-C₂₀ alkyl group; a C₆-C₁₈ aryl group; a C₇-C₂₀ arylalkyl or alkylaryl group; a —(CH₂)ₙ—CO—NR′—SR group wherein n is an integer of from 1 to 20, extremes included, and R′ and R are defined above; an —Ar—CO—NR′—SR group, wherein Ar represents a C₆-C₁₈ arylidene group, and R′ and R are defined above; an —Ar—CRₐ═CR_{b}—Ar—CO—NR′—SR group, wherein Ar is defined above, Rₐ and R_{b}, which may be the same or different from each other, represent a hydrogen atom, a linear or branched C₁-C₂₀ alkyl group, and R′ and R have the same meanings define above; a Rₑ—NH— group or a (R_{c})₂—N— group wherein the R_{c} groups, which may be the same or different from each other, represent a linear or branched C₁-C₂₀ alkyl groups; a R_{d}—CONH— group or a R_{d}—CON—Rₑ— group, wherein R_{d} and Rₑ, which may be the same or different from each other, represent a linear or branched C₁-C₂₀ alkyl group; or, R″ and R′, considered jointly together with the nitrogen atom and the carbon atom to which they are linked, represent a saturated or unsatured C₃-C₁₀ heterocyclic ring; or
is N-cyclohexylthiophthalimide.

133. The crosslinkable elastomeric composition according to claim 128, wherein said organic or inorganic acid or a derivative thereof (d):
comprise carboxylic acids selected from: maleic acid; fumaric acid; citraconic acid; itaconic acid; acrylic acid; methacrylic acid; butanoic acid pentanoic acid; hexanoic acid; heptanoic acid; octanoic acid; phthalic acid; salicylic acid; benzoic acid; sulfur containing carboxylic acids, thiodipropionic acid, dithiodipropionic acid; or mixtures thereof; or
comprise phosphoric acids selected from: metaphosphoric acid; triphosphoric acid; pyrophosphoric acid; alkyl phosphoric acids, di-2-ethylhexyl phosphoric acid, mono-dodecyl phosphoric acid; aryl or alkylaryl phosphoric acids, phenyl phosphoric acid, tolyl phosphoric acid, xylyl phosphoric acid, octylphenyl phosphoric acid; or mixtures thereof; or
comprise sulfonic acids selected from: alkyl sulfonic acids, methanesulfonic acid, ethanesulfonic acid, propane sulfonic acid, 2-butane sulfonic acid; aryl or alkylaryl sulfonic acids, toluenesulfonic acid, p-dodecylsulfonic acid, tetra-propylbenzenesulfonic acid, acetyl p-didecylsulfonic acid, 1-naphthalenesulfonic acid, 2-naphthalene sulfonic acid; or mixtures thereof; or
comprise boric acids selected from: metaboric acid; pyroboric acid; alkyl boric acids, methylboric acid, ethylboric acid, butylboric acid; aryl boric acids, phenylboric acid; or mixtures thereof; or
comprise a derivative of the organic or inorganic acid selected from: esters, anhydrides, halides, imides, amides, or mixtures thereof; or
is phthalic anhydride.

134. The crosslinkable elastomeric composition according to claim 128, further comprising 0 phr to 120 phr of at least one carbon black reinforcing filler (e).

135. The crosslinkable elastomeric composition according to claim 128, further comprising 0 phr to 10 phr of at least one silane coupling agent (f), wherein said silane coupling agent (f) is selected from a silane having at least one hydrolizable silane group which may be identified by the following general formula (III):
(R₅)₃Si—CₙH₂ₙ—X (III)
wherein the R₅ groups, which may be the same or different from each other, are selected from: alkyl, alkoxy or aryloxy groups or from halogen atoms, on condition that at least one of the R₅ groups is an alkoxy or aryloxy group; n is an integer of from 1 to 6, extremes included; X is a group selected from: nitroso, mercapto, amino, expoxide, vinyl, imide, chloro, —(S)ₘCₙH₂ₙ—Si—(R₅)₃, or —S—COR₅, in which m and n are integers of from 1 to 6, extremes included and the R₅ groups are defined above.

136. The crosslinkable elastomeric composition according to claim 128, further comprising 0 phr to 15 phr of at least one methylene donor compound (g):
wherein said methylene donor compound (g) is selected from: hexamethylenetetramine; hexamethoxymethlmelamne; formaldehyde; paraformaldehyde; trioxane; 2-methyl-2-nitro-1-propanal; substituted melamine resins, N-substituted oxymethylmelamine resins; glycoluril compounds, tetramethoxymethyl glycoluril; urea-formaldehyde resins, butylated urea-formaldehyde resins; or mixtures thereof.

137. The crosslinkable elastomeric composition according to claim 128, further comprising 0 phr to 20 phr or at least one methylene acceptor compound (h), wherein said methylene acceptor compound (h) is selected from: resorcinol; catechol; hydroquinone; pyrogallol; phloroglucinol; 1-naphthol; 2-naphthol; phenolic resins; phenolic resins obtained from the condensation of a substituted phenol with an aldehyde, formaldehyde, acetaldehyde, furfural; or mixtures thereof.

138. The crosslinkable elastomeric composition according to claim 128, further comprising 0 phr to 10 phr of:
discontinuous fibres (i): or
discontinuous fibres (i) comprising aramid fibres; or
discontinuous fibres (i) comprising aramid fibres of short fibrillated poly(paraphenylene-terephthalamide) fibres; or
discontinuous aramid fibres predispersed in a polymer matrix selected from: natural rubber, butadiene/styrene copolymers, ethylene/vinyl acetate copolymers; or
discontinuous fibres (i) selected from: fibres based on other polyamides, on polyesters, on polyolefins, on polyvinyl alcohol; glass fibres; natural fibres, cellulose, lignine; or mixtures thereof.

139. The crosslinkable elastomeric composition according to claim 128, wherein at least one additional reinforcing filler is present in said crosslinkable elastomeric composition in an amount of 0 phr to 120 phr.

140. The crosslinkable elastomeric composition according to claim 139, wherein said additional reinforcing filler is silica.

141. The crosslinkable elastomeric composition according to claim 140, further comprising at least one silane coupling agent (d)
selected from a silane having at least one hydrolizable silane group which may be identified by the following general formula (III):
(R₅)₃Si—CₙH₂ₙ—X (III)
wherein the R₅ groups, which may be the same or different from each other, are selected from: alkyl, alkoxy or aryloxy groups or from halogen atoms, on condition that at least one of the R₅ groups is an alkoxy or aryloxy group; n is an integer of from 1 to 6, extremes included; X is a group selected from: nitroso, mercapto, amino, epoxide, vinyl, imide, chloro, —(S)ₘCₙH₂ₙ—Si—(R₅)₃, or —S—COR₅, in which m and n are integers of from 1 to 6, extremes included, and the R₅ groups are defined above.

142. A crosslinked manufactured article obtained by crosslinking a crosslinkable elastomeric composition defined according to claim 128.
